(19) United States
(12) Patent Application Publication
(10) Pub. No.: US 2021/0239890 A1
(43) Pub. Date: Aug. 5, 2021

(54) LOCKING VARIABLE NEUTRAL DENSITY FILTER

(71) Applicant: Jeffrey Overall, Costa Mesa, CA (US)

(72) Inventor: Tyler Wilson, Huntington Beach, CA (US)

(73) Assignee: Polar Pro Filters, Inc., Costa Mesa, CA (US)

(21) Appl. No.: 17/198,051

(22) Filed: Mar. 10, 2021

(51) Int. Cl. G02B 5/20; G02B 27/28; G02B 7/00

(52) U.S. Cl. CPC G02B 5/205; G02B 7/006; G02B 27/281

(57) ABSTRACT

A variable neutral density filter with rotation detents to prevent cross-polarization. Locking means enable creation of a plurality of lock positions, each lock position creating a specific light transmissive setting.

### FIELD OF INVENTION

The present invention relates to the filtration of light in photography. Specifically, it provides a Variable Neutral Density camera filter capable of locking at multiple orientations, each of the orientations providing specific light alteration.

### RELATED APPLICATIONS

This application claims priority to provisional application Ser. No. 63/050,348, filed on Jul. 10, 2020, by the present inventor, which is incorporated by reference in its entirety.

### BACKGROUND

Neutral density (“ND”) filters are used in photography and videography to reduce or modify the light impinging a camera lens. Fractional transmittance is the measure of the percentage of light penetrating an ND filter. There exist multiple quantification systems to measure, or rate an ND filter's fractional transmittance. Two of the most common rating systems are 1) f-stop reduction and 2) ND number.

Each f-stop reduction decreases the fractional transmittance an additional 50%: a 1-stop filter has a fractional transmittance of 50%; a 2-stop filter has a fractional transmittance of 25%; a 3-stop filter has a fractional transmittance of 12.5%; etc.

ND number is also directly correlated to light transmittance. The ND number is the denominator, if the numerator is 1, of the fractional transmittance of the filter: ND2 filter has a fractional transmittance of 50%; an ND4 has a fractional transmittance of 25%; an ND8 has a fractional transmittance of 12.5%; etc.

It is common for photographers to carry multiple ND filters with different fractional transmittance ratings. This enables optimization image color saturation in different lighting, and variation in shutter speed and other camera settings for alternative effects. Use of filters with one ND measurement has the drawback of requiring storage of breakable filters and the hassle of installation and removal of the individual filters from the camera lens. And purchasing multiple individual ND filters may also be cost prohibitive.

Variable neutral density (VND) filters remedy these problems. VND filters use two polarizer glass elements, each having its own linear polarizing layer. The two layers of glass are placed at opposition to each other. Light transmittance through the filter decreases as the glass layers are rotated so that the linear polarizing layers are relatively closer to 90 degrees relative to each other. A VND's ability to alter the amount of light transference enables a user to create multiple ND ratings with the same filter.

Prior art VND filters have multiple shortcomings. Cross-polarization may occur when the filters are moved beyond the minimum or maximum ND ratings for the respective polarizer glass elements. Cross-polarization may cause an obscurity of the image data captured.

Prior art VND filters were also incapable of locking in certain ND ratings. Without the ability to lock the camera, a photographer could calibrate the VND to the desired rating, only to have it unlock inadvertently while moving the camera or storing the VND. Additionally, prior art VND's do not provide haptic feedback as to what ND rating the VND filter is at.

The current invention resolves these issues by limiting the rotation range of the VND filter and providing an ND rating specific locking system.

### SUMMARY OF INVENTION

A Locking Variable Neutral Density (“VND”) filter enabling a range of light transmittance reduction is disclosed. A circular front frame and circular back frame are operatively coupled. The front frame couples a front glass element along its perimeter. The back frame couples a back-glass element along its perimeter. The operative coupling enables rotation of the frames relative to each other and around an axis extending perpendicularly from the center of the planar surfaces of the glass elements.

One frame may comprise locking means and the other frame may comprise a plurality of lock sockets. Locking means may be capable of coupling with each the lock sockets, enabling the frames to engage and lock in a plurality of lock positions. Each lock position may create particular light transmittance reduction, i.e. a particular f-stop rating or ND rating.

Haptic feedback may indicate when a lock position is achieved. The locking means and a lock socket may create rotation resistance when coupled in a lock position. The rotation resistance may be configured to a predetermined pound-foot or pound inch measurement. The rotation resistance may be calibrated to enable manual torqueing of the frames out of a locked position while preventing inadvertent movement—due to shaking, bumping, filming, etc.—out of the locked position.

### BRIEF DESCRIPTION OF DRAWINGS

FIG. 1A is a front perspective view of a Locking VND filter

FIG. 1B is a back perspective view of a Locking VND filter

FIG. 2A is an exploded front perspective view of a VND filter

FIG. 2B is a right side exploded view of a VND filter

FIG. 3A is a front view of a VND filter

FIG. 3B is a section view of a VND filter taken from FIG. 3A

FIG. 3C is an enlarged view of the VND filter locking aspects, taken from FIG. 3B

FIG. 4 is a isolated view of the inner surfaces of a back frame and a front frame

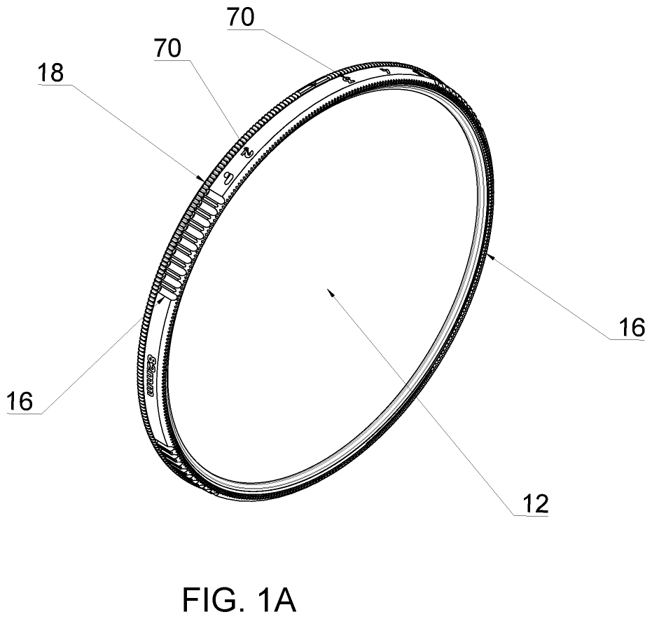

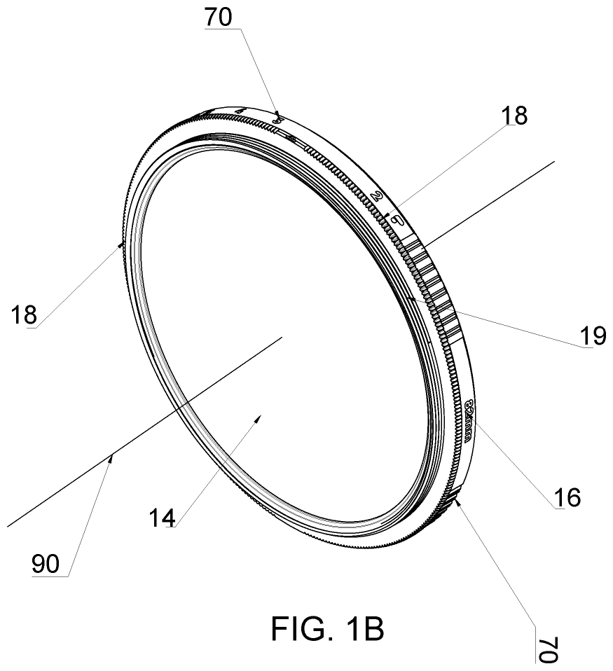

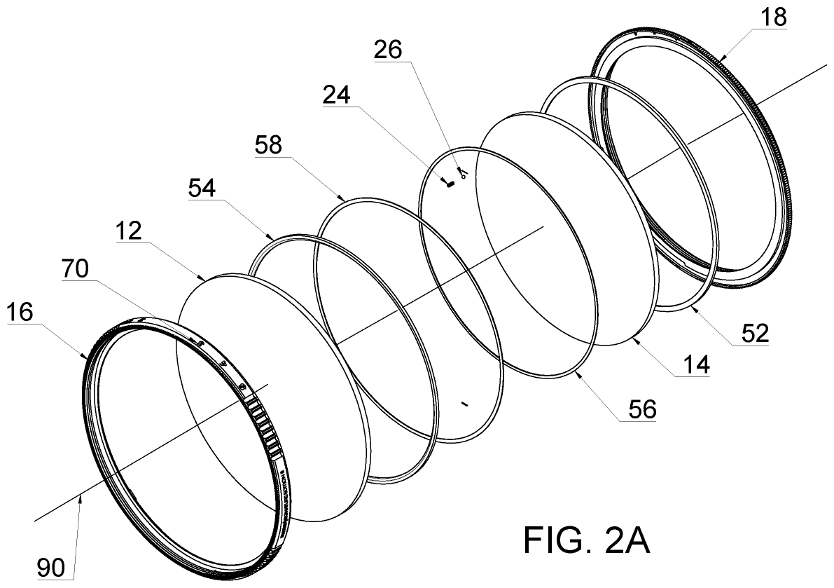

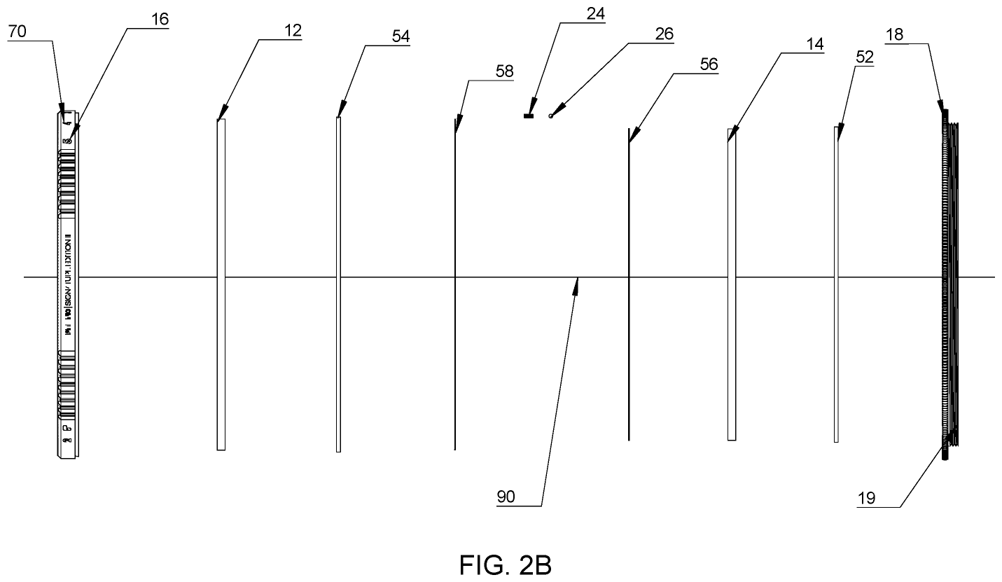

### DRAWING NUMERAL LIST

10 VND filter
12 front glass
14 back glass
16 front frame
18 back frame
19 threads
20 lock socket
20a 2-stop lock position
20b 3-stop lock position
20c 4-stop lock position
20d 5-stop lock position
22 bearing socket
23 lock position
24 spring
26 ball bearing
28 bumper
29 rotation ridge
30 rotation detent
32 rating range
34 rotation interval
36 transmission range
38 coupling groove
42 minimum nd rating
44 maximum nd rating
52 back shared trim ring
54 front shared trim ring
56 back tape ring
58 front tape ring
60 front frame inner surface
62 back frame inner surface
70 stop indicator
90 axis

### DETAILED DESCRIPTION OF THE DRAWINGS

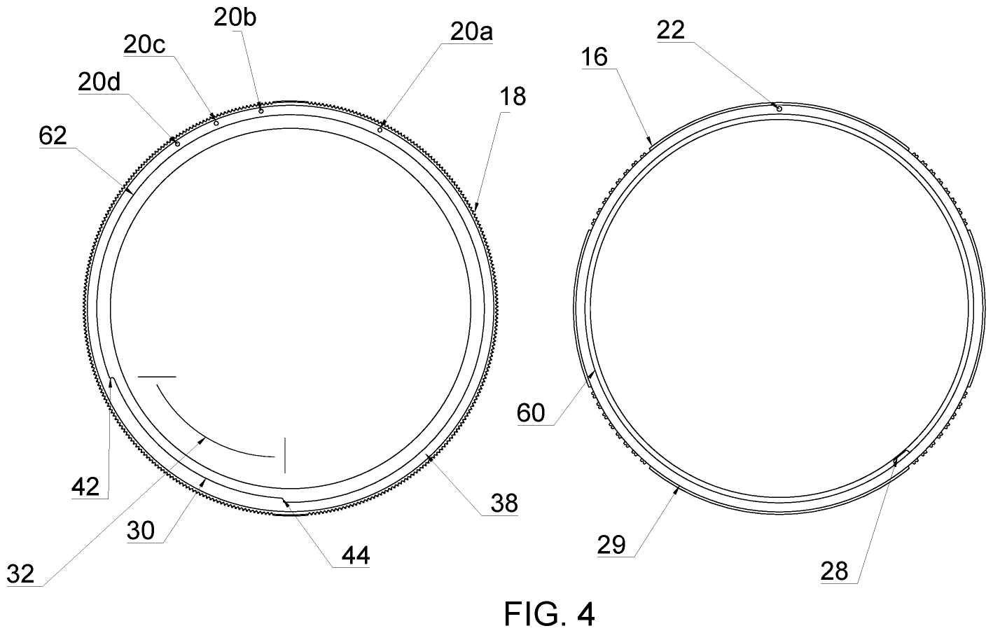

A front glass 12 and back glass 14 comprise the light filtering aspects of a Locking Variable Neutral Density (“VND”) filter 10. A back frame 18 couples the back-glass element 14. The back frame 18 is circular and configured to couple with a camera lens. A coupling ring 19 may extend from a back surface of the back frame 18. Threading or other coupling means may line the inner and/or outer surface of the coupling ring 19 or extend therefrom. The coupling ring 19 may provide means to couple with a camera lens or other camera component. An inner surface of the back frame 18, i.e. the surface opposing the surface from which the coupling ring extends from, may comprise a coupling groove 38 (see FIG. 4).

A front frame 16 couples the front glass 12. The front frame 16 comprises a rotation ridge 29. The rotation ridge 29 extends from the radial, inner surface of the front frame 16. The rotation ridge 29 may extend into the coupling groove 38, thereby operatively coupling the front frame 16 and back frame 18. Operative coupling may enable rotation of the frames 16, 18 relative to each other, while maintaining alignment of the frames 16, 18 and thus alignment of the glass elements 12, 14.

When the back frame 18 is coupled with a camera lens it remains stationary relative to the coupled camera. The front frame 16 remains free to rotate around an axis 90 extending perpendicularly from the center of the planar surfaces of the front glass 12 and back glass 14.

The back frame 18 may comprise a rotation detent 30. The rotation detent 30 may define a rating range 32. The front frame 16 may comprise a bumper 28. The bumper 28 may protrude from the inner surface of the front frame 18. The bumper 28 may be disposed within the rotation detent 30 when the frames 16, 18 are operatively coupled. The bumper 28 is prevented from rotation out of the rotation detent 30, thereby limiting rotation of the front glass 12 to the rating range 32. The rotation detent 30 may comprise a minimum ND rating 42 and a maximum ND rating 44 (see FIG. 4). The maximum ND rating 44 and the minimum ND rating 42 may comprise the limits of the rating range 32. An embodiments rating range 32 may be configured to prevent rotation orientations causing cross-polarization and/or color shifting.

The back frame 18 may comprise a plurality of lock sockets 20. The exemplary embodiment comprises four lock sockets 20 (see FIG. 4).

The front frame 16 may comprise locking means. A bearing socket 22, housing a spring 24, and ball bearing 26 may comprise exemplary locking means. The spring 24 and ball bearing 26 may align with the locking sockets 20 at certain rotation orientations. The spring 24 may urge the ball bearing 26 towards the back frame 18. When the bearing socket 22 and a lock socket 20 are rotated to align, the ball bearing 26 is forced into the lock socket 20, whereby a lock position 23 is created.

The spring 24 urges the ball bearing 26 into an aligned lock socket 20 with sufficient force to create rotation resistance. Rotation resistance prevents inadvertent movement out of the locked position 23. Locking means and an engaged lock socket 20 may create rotation resistance enabling manual torqueing of the front frame 16 out of a locked position while preventing inadvertent unlocking due to shaking or other movement of the VND filter 10.

Engagement of the ball bearing into a lock socket 20 may provide haptic feedback detectable to a user. Insertion of locking means into a lock socket 20 may create haptic feedback, enabling the user to feel when the frames (16, 18) have been rotated into a locked position. Stop indicators 70 on the outer-perimeter surface of the front frame 16 and/or the outer-perimeter surface back frame 18 may indicate the current lock position 23. In the exemplary model a 2f-stop lock position 20(a) corresponds to a “2” stop indicator; a 3f-stop lock position 20(b) corresponds to a “3” stop indicator; a 4f-stop lock position 20(c) corresponds to a “4” stop indicator; a 5 f-stop lock position 20(d) corresponds to a “5” stop indicator.

The bumper 28 and rotation detent 30 may be configured so that lock positions are created when the bumper abuts either the minimum 42 or maximum 44 ND ratings, i.e. the limits of the rating range 32 coincide with lock positions 23, 23(a) and 23(d) respectively.

The front glass 12 and back glass 14 may be circular polarizers capable of light transmission reduction. “Polarized glass,” “polarized filter,” or “polarizer” may be used herein to refer to light transmissive elements capable of altering the electric quality of impinging light. The front glass 12 and back glass 14 elements may be placed in opposition to each other, as is known in the art.

The front glass 12 on an exemplary 2-5 stop VND filter 10 embodiment may be a polarizer filter and also a neutral density 4 filter. Neutral density 4 light stopping ability is the equivalent of two stops of light filtration.

When a 2-5 stop embodiment is oriented with the bumper 28 abutting at the minimum ND rating 42, the front glass 12 and back glass 14 may block 75% of light, i.e. a 25% fractional transmittance. This is equivalent to ND4 filtration or 2 stops in light transmission reduction.

The bumper 28 serves as the reference point for directional rotation herein, i.e. rotation towards the maximum 44 ND rating refers to movement of the bumper within the rotation detent towards the maximum 44 ND rating and away from the minimum 42 ND rating.

As the front glass 12 is rotated towards the maximum 44 ND rating, the polarization aspects of the glass elements 12, 14 will block a greater amount of light. A lock socket 20 may be configured to create a 3-stop lock position 23. At the 3-stop lock position 23 87.5% of light is filtered, i.e. a 12.5% fractional transmittance. This is equivalent to an ND 8 filtration rate—the equivalent to a 3-stop reduction in light transmission.

Similarly, an additional lock socket 20 may be configured to create a 4-stop lock position 20(c). At the 4-stop lock position 23(c) 93.75% of light is filtered, i.e. a 6.25% fractional transmittance. This is the equivalent of an ND 16 filtration or 4 stops of light transmission reduction.

A socket 20 may be configured to create a 5-stop lock position 20(d). The bumper 28 may abut or be located closely to the maximum 44 ND rating when oriented in the 5-stop lock position. At the 5-stop position 23(d) 96.875% of light is filtered, i.e. a 3.125% fractional transmittance. This is equivalent to an ND 32 filtration or 5 stops of light transmission reduction.

Other embodiments may comprise glass elements and configuration enabling a different rating range. An exemplary 6-9 stop rating range may be preferred for longer exposure photography, or image capture in brighter settings. Locking means and lock sockets in such a 6-9 stop embodiment may be configured to create lock positions at 6f-stop, 7f-stop, 8f-stop, and 9f-stop light transmittance reduction orientations.

The front frame 16 may comprise a front frame inner surface 60. The front frame frame inner surface 60 may abut a back frame inner surface 62 (see FIG. 4). A rotation ridge 29 protrudes circumferentially from the inner surface of the front frame 16. The coupling groove 38 may house the rotation ridge 29, extending around it, and keeping it in alignment. The coupling groove 38 allows sufficient tolerancing to allow the rotation ridge 29, and in turn the front frame 16 to rotate relative to the back frame 18. The rotation ridge 29 and coupling groove 38 may be beveled to achieve such operative coupling.

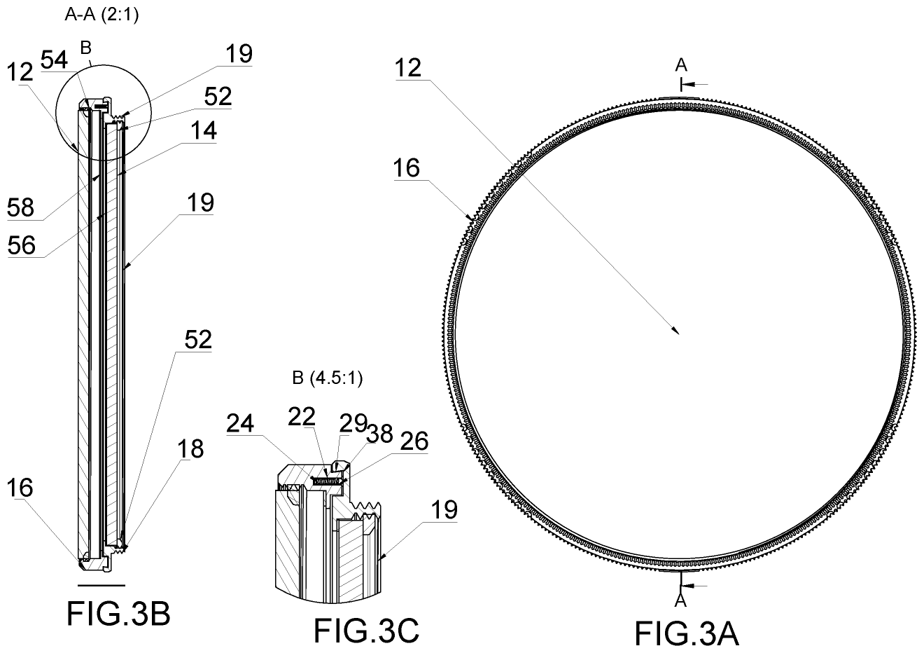

A bearing socket 22 in the rotation ridge 29 may house a spring 24 and ball bearing 26 (see FIGS. 3C and 4). The ball bearing 26 may extend from the bearing socket 22 and abut the coupling groove 38. The ball bearing 26 and spring 24 may operatively couple, enabling the ball bearing 26 to rotate. Such operative coupling may reduce friction and interference of rotation of the front frame 16.

The lock socket(s) 20 are configured to removably couple the ball bearing when the frames are aligned in a lock position 23. Lock sockets 20 intrude into the back frame a sufficient distance to prevent movement out of a locked position 23 unless a predetermined amount of torque is applied to the front frame 16.

The foregoing disclosure is intended to be illustrative and not limiting the scope of the invention. Merely exemplary embodiments and methods related to the invention are discussed and described. As will be understood by those familiar to the art, the disclosed subject matter may be embodied in other forms or methods without departing from the essence of the invention.

I claim:

1. A camera filter, comprising:
a. two glass elements that are circular and polarized;
b. two frames, each of the frames coupling a glass element at the perimeter;
c. the two frames operatively coupling, whereby enabling:
i. rotation of the glass elements relative to each other; and
ii. around an axis extending perpendicular from a planar surface of the two glass elements; and
d. the two frames comprising locking means and a plurality of lock sockets;
e. the locking means and plurality of lock sockets being configured to engage and thereby create a plurality of lock positions.

2. The camera filter in claim 1, wherein the engagement of the locking means and the plurality of lock sockets provides haptic feedback to a user upon creation of one of the plurality of lock positions.

3. A camera filter, comprising:
a. a front glass element and a back glass element, both glass elements comprising polarizer;
b. the front glass element coupling with a front frame;
c. the back glass element coupling with the back frame;
d. the back frame operatively coupling with the front frame, whereby the frames are capable of rotation relative to each other;
e. the back frame comprising a rotation detent;
f. the front frame comprising a bumper, the front frame being oriented so the bumper is positioned within the rotation detent;
g. the rotation detent defining a rotation range, the bumper being confined to the rotation range;
h. the front frame comprising a ball bearing;
i. the back frame comprising a plurality of lock sockets;
j. the ball bearing and the plurality of lock sockets aligning so that when the front frame and back frame are rotated to predetermined orientations the ball bearing engages one of the plurality of lock sockets to create a lock position;
k. the lock positions comprising a locking force, the locking force preventing rotation of the frames relative to each other against a predetermined amount of torque.

4. The camera filter in claim 2, wherein the lock positions correspond to stop intervals, whereby the front glass element and back glass element reduce a predetermined percentage of light transmission.

5. The camera filter in claim 6, wherein the locking means are a spring and a ball bearing.

6. A camera filter, comprising:
a. a front glass element and a back glass element, both glass elements comprising polarizer;
b. the front glass element coupling with a front frame;
c. the back glass element coupling with the back frame;
d. the back frame operatively coupling with the front frame, whereby the frames are capable of rotation relative to each other;
e. the front frame comprising a rotation detent;
f. the back frame comprising a bumper, the front frame being oriented so the bumper is positioned within the rotation detent;
g. the rotation detent defining a rotation range, the bumper being confined to the rotation range;
h. the back frame comprising a locking means;
i. the front frame comprising a plurality of lock sockets;
j. the ball bearing and the plurality of lock sockets aligning so that when the front frame and back frame are rotated to predetermined orientations the ball bearing engages one of the plurality of lock sockets to create a lock position;
k. the lock positions comprising a locking force, the locking force preventing rotation of the frames relative to each other against a predetermined amount of force.

7. The camera filter in claim 6, wherein the lock positions correspond to stop intervals, whereby the front glass element and back glass element reduce a predetermined percentage of light transmittal.

8. The camera filter in claim 6, wherein the locking means are a spring and a ball bearing.

9. A camera filter, comprising:
a. a front glass element and a back glass element, each of the glass elements comprising a polarizer;
b. a front frame coupling the front glass element and a back frame coupling the back glass element;
c. the front frame operatively coupling with the back frame, whereby the frames are capable of rotation in opposing directions relative to an axis perpendicular to the planar surfaces of the glass elements;
d. the front frame comprising locking means;
e. the back frame comprising a plurality of lock sockets;
f. said locking means creating a unique lock position and each of the plurality of lock sockets creating a lock position when aligned;
g. comprising a plurality of lock sockets;
h. the locking means and the plurality of lock sockets configured so as to align when the front frame is rotated within a rating range;
i. each of the plurality of locking sockets configured to couple with and engage and removably couple with the locking means when aligned, thereby creating a lock position.
j. a front frame operatively coupling with a back frame;
k. a front glass element and a back glass element, both the front glass element and the front glass element being cylindrical and capable of filtering polarized light;
l. the front frame coupling the front glass element along the perimeter of the front glass element;
m. the back frame coupling the back glass element along the perimeter of the front glass element;
n. the front frame comprising a bearing socket housing locking means;
o. the back frame comprising a 2-stop lock socket, a 3-stop lock socket, a 4-stop locking socket, and a 5-stop locking socket;
p. the locking means and the plurality of lock sockets configured so as to align when the front frame is rotated within a rating range;
q. each of the plurality of locking sockets configured to couple with and engage and couple with the locking means when aligned, thereby creating a lock position.
